(19) United States
(12) Patent Application Publication
(10) Pub. No.: US 2003/0033912 A1
(43) Pub. Date: Feb. 20, 2003

(54) Torque tool socket release method and apparatus

(76) Inventors: Donald W. Coffland, Seattle, WA (US); Frederick L. Knoll, Kent, WA (US)

Correspondence Address: THE BOEING COMPANY, P.O. BOX 3707 M/C 13-08, SEATTLE, WA, 98124-2207, US

(21) Appl. No.: 09/847,488

(22) Filed: May 2, 2001

(51) Int. Cl. B25B 23/16

(52) U.S. Cl. 81/177.85

(57) ABSTRACT

A positive socket retention and release on a power torque tool utilizing a spring-loaded push rod through the head of the tool. A modified socket retention post is used with an angle pin on the end of the shaft actuating the post via an angle hole. A spring returns the push rod to original position, locking the post. A pin guard is used to prevent inadvertent actuation.

### BACKGROUND OF THE INVENTION

A nut runner or nut setter typically includes an air motor or electric motor that drives a typically square section sized to accept a plurality of sockets or implements that perform their function when turned or rotated by the motor. Retention of the sockets or implements in many applications is critical to prevent inadvertent disengagement of that part of the tool into the assembly being worked on. The socket or implement may come off or fall down into a complex assembly becoming “foreign objects or debris” otherwise known as FOD that must be found and removed before work can resume because of the damage or injury that may result. It is sometimes also a time consuming nuisance to reattach the socket or implement before assembly can continue.

Generally, prior mechanisms that are supplied on power driven tools have a spring-loaded retention post or pin. These prior mechanisms are normally in the extended position so as to positively retain the socket or implement in place. They require a separate punch like tool to push them out of the way when installation or removal of the socket or implement is desired. This then poses the problem of finding the proper diameter tool and/or having it with the operator at all times in the event it is desired to remove and/or install another socket or implement from the power driven nut runner or nut setter. This process has proven in the past to be very time consuming, annoying and disruptive to manufacturing processes.

Non power tool mechanisms that perform positive retention with built in actuator mechanisms for removal of sockets or implements are more complex than desired for performing the required function e.g. as seen in U.S. Pat. No. 4,794,828 issued Jan. 3, 1989 to Olson which requires more than two pieces and a specially configured pin 50 with slot.

### SUMMARY OF THE INVENTION

Accordingly, it is an object of the present invention to provide a built-in actuator on a power driven nut runner or nut setter.

Another object of the present invention is to provide a positive retention and releasing mechanism for a socket or fitting on a power driven nut runner or nut setter.

An important feature of the present invention is that the main work of providing positive retention and releasing of the socket or fitting is done utilizing two pieces: a sliding push rod, and a retention post or pin that move perpendicular to each other when the mating surfaces are engaged.

A further important feature of the present invention is the provision of a shielding member that partially encapsulates the hand actuated end of the sliding push rod so that the positive retention mechanism is not inadvertently activated consequently releasing the socket or fitting.

The present invention provides a method for quickly and easily retracting the post via a mechanism within the torque tool head. An embodiment of the invention utilizes a spring-loaded push rod through the head of the tool which mates with a modified socket retention post. When depressed, the push rod draws the post inward via an angle pin thereby allowing the socket to be removed or installed. After socket removal or installation, a spring returns the push rod to its original position, locking the post in the outward position without the requirement of separate tools. The socket release becomes part of the tool, permitting a function that can be performed quickly.

### BRIEF DESCRIPTION OF THE DRAWINGS

FIG. 1 is a simplified cutaway view of the socket retention post engaged;

FIG. 2 is a simplified cutaway view of the present socket retention post retracted;

FIG. 3 is a side view of a prototype nutrunner tool head showing the socket retention post engaged;

FIG. 4 is a side view of a prototype nutrunner tool head showing the socket retention post retracted;

FIG. 5 is illustrative of a close-up view of the prototype tool head with socket retention post engaged;

FIG. 6 is a close-up view of the prototype tool head with socket retention post retracted; and,

FIG. 7 is a cross sectional view of the present nut runner or nut setter with a 90 degree angle head, air motor or electric motor section not shown for simplicity.

### DETAILED DESCRIPTION OF THE PREFERRED EMBODIMENT

The present invention hereinafter described provides a method for easily and quickly retracting the post by means of a mechanism within the torque tool head.

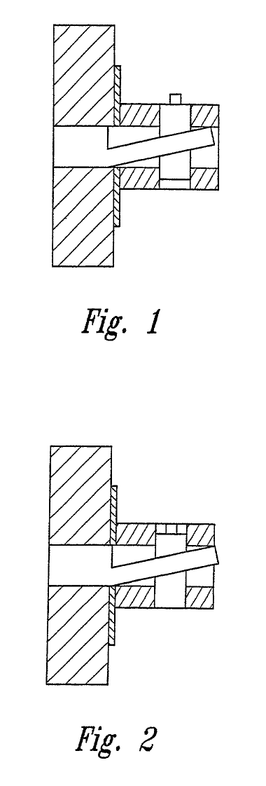

Turning now briefly to FIG. 1, there is seen a torque tool release apparatus which utilizes a spring-loaded push rod through the head of the tool, which mates with a modified socket retention post. When depressed, the push rod draws the post inward via an angle pin allowing the socket to be removed or installed as shown in FIG. 2. After socket removal or installation, a spring returns the push rod to its original position, locking the post in the outward position. No separate tools are required. The hereinafter described socket release becomes part of the tool, and the function can be performed instantaneously.

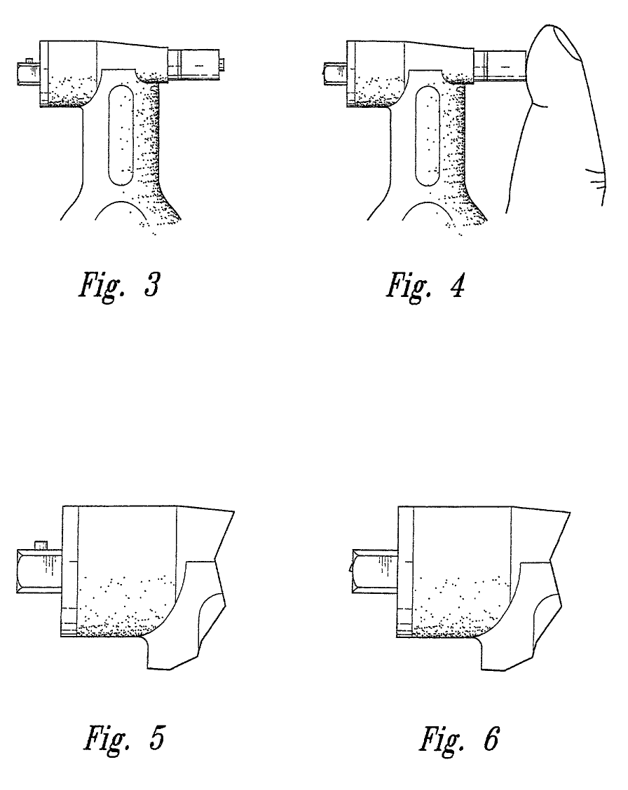

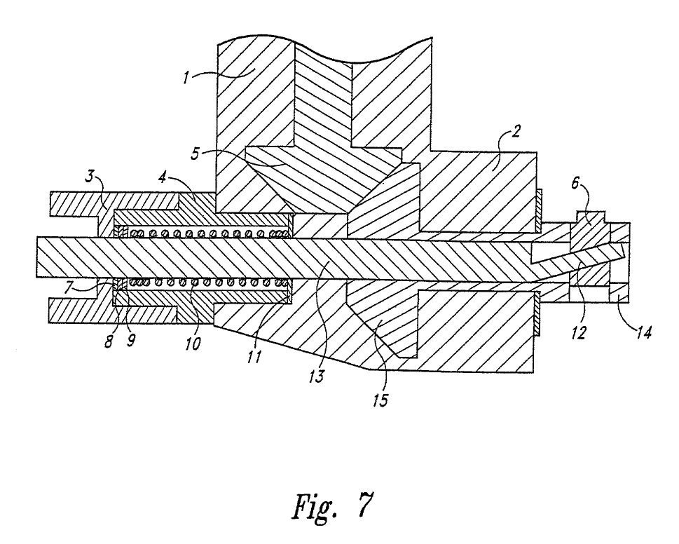

An overview of the present torque tool socket release method and apparatus is shown in FIGS. 3 through 6. FIG. 3 shows the present nutrunner tool head with socket retention post engaged. FIG. 4 shows the nutrunner tool head with socket retention post retracted. FIG. 5 is a close-up of the present tool head with socket retention post engaged, and FIG. 6 is a close-up of the tool head with socket retention post retracted.

Turning now to a detailed description of the present torque tool socket release apparatus as shown in cut away view, it can be seen that the mechanism comprises a nutrunner or nut setter housing 1 which is sectioned near the 90-degree angle head 2 of the power tool. Bevel gears 5 (motor side) and 15 (output side) transfer the motor driven power to the nut runner or nut setter square drive 14 that is engaged into a socket or implement. The socket or implement is retained onto the square drive by the socket retention post 6 that moves perpendicular to push rod 13.

When the mating surfaces of socket retention post 6 and angle pin 12 slide past each other, the socket or implement is either positively retained or released. When socket retention post 6 is extended outward in an engaged position, the socket or implement is retained.. If socket retention post 6 is retracted into nut runner square drive 14, the socket or implement can be slid on or off of the square drive. Return spring 10 is arranged to press against washer 9 that rides and presses against E-clip 8 that snaps into a groove cut into push rod 13.

In normal operation, spring 10 is slightly compressed, keeping push rod 13 retracted thereby keeping socket retention post 6 in the engaged position. The socket or implement is thereby held in place until it is manually released by pressing push rod 13. At this point, return spring 10 would be further compressed and would return to the retracted position when pressure on push rod 13 is released. Washer 7 is provided in the present torque tool socket release apparatus to minimize wear that may occur on the end cap if E-clip 8 rotates with push rod 13. Press fit spring guide 4 and washer 11 that rides against the spring are herein shown as separate elements but alternatively could be formed as a single structure. Push-rod guard 3 is shown as part of end cap which is attached to press fit spring guide 4.

What is claimed is:

1. A mechanism for providing positive retention and release of a socket or fitting on a power driven nut runner or nut setter utilizing a push rod that interfaces with a sliding post or pin having mating surfaces for developing movement in perpendicular directions.

2. The mechanism of claim 1 comprising first and second pieces, said first piece comprising a sliding shaft, said second piece comprising a post or pin, and said first and second pieces moving perpendicular to each other when the mating surfaces of said first and second pieces are engaged.

3. A method of shielding or partially encapsulating an exposed portion or button end of a push rod so that a positive retention mechanism is prevented from inadvertent activation by contacting said exposed portion thereby releasing a socket or fitting.

4. The mechanism of claim 2 wherein said sliding shaft has a full or partial cross section other than of round configuration for preventing a binding rotation when said sliding shaft interfaces with a similar cross sectional area inside a tool head or housing thereby allowing said mating surfaces which provide the perpendicular motion component to provide alignment for smooth motion.

5. The mechanism of claim 2 wherein said sliding shaft has a full or partial cross section o f round configuration.

6. A method for retracting a socket retention post in a torque tool head comprising the steps of:
providing a spring-loaded pushbutton pin through the torque tool head which mates with a socket retention post;
depressing said spring-loaded pushbutton pin to draw said socket retention post inward via an inclined surface thereby allowing a socket to be removed or installed; and,
removing or installing the socket thereby providing spring return of said spring-loaded pushbutton pin to initial position locking said socket retention post in the outward position.

7. In combination in a torque tool socket release apparatus:
a sliding shaft and pin which move perpendicular to each other when their mating surfaces are engaged;
a positive retention mechanism; and,
a shielding member partially encapsulating the hand actuated or exposed end of said sliding shaft so that said positive retention mechanism does not inadvertently activate thereby releasing the socket.

8. In combination:
a return spring (10);
an angle pin (12);
a nut runner power tool head (2);
a push rod (13);
a socket retention post (6);
a nut runner square drive (14);
a nut runner gear (15) for transferring motor driven power to said nut runner square drive (14);
a socket retention post (6) for retaining a socket on said square drive (14);
said socket retention post (16) moving perpendicular to said push rod (13) for retaining the socket on said square drive (14);
mating surfaces of said socket retention post (6) and said angle pin (12) disposed for sliding past each other to positively retain or release the socket; and,
said return spring (10) compressed to keep said push rod (13) retracted thereby maintaining socket retention post (6) in an engaged position.
